(19) United States
(12) Patent Application Publication
(10) Pub. No.: US 2019/0042997 A1
(43) Pub. Date: Feb. 7, 2019

(54) DISTINGUISHING JOB STATUS THROUGH MOTION ANALYSIS

(71) Applicant: Aeris Communications, Inc., San Jose, CA (US)

(72) Inventors: Anupam Bagchi, San Jose, CA (US); Subramanian Balakrishnan, Cupertino, CA (US); Satish Balaso Mane, Pune (IN)

(21) Appl. No.: 16/054,084

(22) Filed: Aug. 3, 2018

Related U.S. Application Data
(60) Provisional application No. 62/541,278, filed on Aug. 4, 2017.

(51) Int. Cl. G06Q 10/06; G06Q 50/02; H04W 4/02; G06F 15/18; H04W 4/30

(52) U.S. Cl. CPC G06Q 10/063114; G06Q 50/02; H04W 4/30; G06F 15/18; H04W 4/025

(57) ABSTRACT

A computer-implemented method and system for distinguishing job status through motion analysis are disclosed. The method includes receiving device information from a device, determining a predetermined set of features from the received device information, and applying rules to determine if the movement of the device can be classified as farming or non-farming activity. The system includes a device having a location tracking system and a server having a storage database, an analytics system and a rules engine, wherein the server receives device information transmitted by the device, the storage database stores the received device information, the analytics system analyzes the device information to determine a predetermined set of features from the received device information, and the rules engine provides rules to determine if the movement of the device can be classified as farming or non-farming activity.

### CROSS-REFERENCE TO RELATED APPLICATIONS

Under 35 USC 119(e), this application claims priority to U.S. provisional application Ser. No. 62/541,278, entitled “DISTINGUISHING JOB STATUS THROUGH MOTION ANALYSIS”, filed on Aug. 4, 2017, all of which is herein incorporated by reference in its entirety.

### FIELD OF THE INVENTION

The embodiments described herein relate generally to cellular networks and more particularly to distinguishing job status through motion analysis.

### BACKGROUND

In many Internet-of-Things (IoT)/Machine-to-Machine (M2M) solutions, particularly running on moving machines, for example, vehicles, it may be useful to the fleet operator to distinguish job status of farming equipment through motion analysis.

### SUMMARY

In one example embodiment, a computer implemented method for distinguishing job status through motion analysis is disclosed. The method includes receiving device information by the server from a device, determining a predetermined set of features from the received device information, and applying rules to determine if the movement of the device can be classified as a farming or non-farming activity.

In another example embodiment, a system for distinguishing job status through motion analysis is disclosed. The system includes a device including a location tracking system and a server including an analytics system further including a storage database and a rules engine, wherein the server receives device information transmitted by the device, the storage database stores the received device information, the analytics system analyzes the device information to determine a predetermined set of features from the received device information, and the rules engine provides rules to determine if the movement of the device can be classified as farming or non-farming activity.

In an embodiment, a non-transitory computer-readable medium having executable instructions stored therein that, when executed, cause one or more processors corresponding to a system having a device and an analytics system including a storage database and a rules engine to perform operations including receiving data comprising device information from the device, determining a predetermined set of features from the received device information, and applying rules to determine if the movement of the device can be classified as farming or non-farming activity.

### BRIEF DESCRIPTION OF THE DRAWINGS

FIG. 1 is an overview diagram for system 100 used for distinguishing job status through motion analysis according to an embodiment described herein.

FIG. 2 illustrates a process 200 used in system 100 for distinguishing job status through motion analysis according to an embodiment described herein.

FIG. 3 is an overview diagram for system 300 used for distinguishing job status through motion analysis according to an embodiment described herein.

FIG. 4 illustrates a process 400 used in system 300 for distinguishing job status through motion analysis according to an embodiment described herein.

FIG. 5 illustrates an exemplary user interface 500 for the system and method for distinguishing job status through motion analysis to an embodiment of the invention.

FIG. 6 illustrates a data processing system 600 suitable for storing the computer program product and/or executing program code relating to for distinguishing job status through motion analysis in accordance with an embodiment described herein.

### DETAILED DESCRIPTION

The embodiments described herein relate generally to cellular networks and more particularly to distinguishing job status through motion analysis. The following description is presented to enable one of ordinary skill in the art to make and use the invention and is provided in the context of a patent application and its requirements. Various modifications to the preferred embodiments and the generic principles and features described herein will be readily apparent to those skilled in the art. Thus, the embodiments described herein are not intended to be limited to the embodiments shown, but is to be accorded the widest scope consistent with the principles and features described herein.

Many Internet-of-Things (IoT)/Machine-to-Machine (M2M) solutions, particularly running on moving machines, for example, vehicles, it may be useful to the fleet operator or owner of farming equipment to distinguish and/or determine job status of the farming equipment through motion analysis, since many times active state of a farming equipment/vehicle is used for billing purposes by the owner who is leasing this vehicle/equipment to the farmer. Determining how long the vehicle/equipment has been used on the field automatically without use of expensive sensors installed on the tools, enables the owner to provide a reasonably accurate bill to the borrower.

Additionally, or alternatively, it may be useful in situations where the farming equipment, e.g, tractors, are rented by a user on hourly/weekly/daily basis which may be provided to different people/farm workers or shared with other users (co-users). In such situations, it may be important for the user to know if the rented equipment is used for the purpose it was rented, duration of such use, area covered by the use, and similar usage parameters if used by co-users if any, etc., or if it was used for farming activity at all. In some remote areas of the planet, the farming areas or zones may not be well defined and/or mapped and hence unknown or with undetermined shape and/or size, or they may be dynamic due to various reasons, e.g., river meandering. For example, where farming area is close to the river bed due to easy access to river water, it may change over time due to river meandering as a result of proximity of the river.

A farming equipment/vehicle, connected to a communication network via a device, for example, SIM, installed in the equipment/vehicle, sends location and/or movement information when in motion to a storage database that may reside on a server or in cloud periodically. The embodiments described herein provide a method to determine whether the equipment/vehicle is active on the job or moving around/travelling that is unrelated to the farming job by analyzing lateral movements of the equipment on the ground. Using this method eliminates the need to install expensive sensors on the vehicle/farming equipment for detecting motion of tools like plow, rakes and such, and instead relies on field motion of the device, e.g., vehicle/farming equipment with a SIM installed in or on it, to make that determination.

In one example embodiment, a computer implemented method for distinguishing job status through motion analysis is disclosed. The method includes receiving device information by the server from a device, determining a predetermined set of features from the received device information, and applying rules to determine if the movement of the device can be classified as farming or non-farming activity.

In another example embodiment, a system for distinguishing job status through motion analysis is disclosed. The system includes a device including a location tracking system and a server including an analytics system further including a storage database and a rules engine, wherein the server receives device information transmitted by the device, the storage database stores the received device information, the analytics system analyzes the device information to determine a predetermined set of features from the received device information, and the rules engine provides rules to determine if the movement of the device can be classified as farming or non-farming activity.

In an embodiment, a non-transitory computer-readable medium having executable instructions stored therein that, when executed, cause one or more processors corresponding to a system having a device and a server including an analytics system having a storage database and a rules engine to perform operations including receiving data comprising device information from the device, determining a predetermined set of features from the received device information, and applying rules to determine if the movement of the device can be classified as a farming or non-farming activity.

In an embodiment, also referred to as scenario 1, streaming data related to the vehicle/farming equipment is analyzed to obtain results within a short period of starting the job. In another embodiment, also referred to as scenario 2, the data is analyzed after a predetermined time interval, for example, every hour, every day, every week etc. and batch analysis is performed at the end of the predetermined time interval, where the result is obtained at the end of the time interval, which may result in a higher degree of confidence.

The analytics system may include a special document database that has GeoJSON support, also known as a location aware database. The analytics system may further provide reporting capabilities and may additionally or alternatively provide deep learning capabilities, for example, in scenario 2. The knowledge extracted from deep-learning and stored in the device database used in scenario 2 is fed into the short-term alerting used in alerting capabilities using small time windows in the recent past of the real time stream processing module of scenario 1.

The benefits of the embodiments described herein include cost savings, applications in various fields and easy adaptability to distinguish different tasks. For example, the biggest impact this method makes is the cost savings it brings to the owner of the vehicle/farming equipment. The active state of farming equipment may be used for usage based billing purposes, for example, by the owner of the equipment who is leasing this equipment to a farmer. Determining how long the vehicle/farming equipment has been used on the field automatically from collected location data for that vehicle/equipment without the use of expensive sensors installed on the tools/farming equipment, enables the owner to provide a reasonably accurate bill to the borrower, since many times active state of a farming equipment/vehicle is used for billing purposes by the owner who is leasing this vehicle/equipment to the farmer. Determining how long the vehicle/equipment has been used on the field automatically, without use of expensive sensors installed on the tools, enables the owner to provide a reasonably accurate bill to the borrower.

Alternatively or additionally, it may be useful in situations where the farming equipment, e.g., tractors or other farming equipment, are rented by a user on hourly/weekly/daily basis and provided to different people/farm workers, or shared with other users (co-users). In such situations, it may be important for the user to know if the rented equipment is used for the purpose it was rented, duration of such use, area covered by the use, and/or similar usage parameters if used by co-users, etc. or if it was used for farming activity at all. In some remote areas of the planet, the farming areas or zones may not be mapped and hence not known, or with undetermined shape and/or size, or may be dynamic as they may change due to various reasons, e.g., river meandering. For example, where farming area is close to the river bed due to easy access to river water, but the farming area may change over time due to river meandering due to the proximity.

The method is generic enough to apply to many kinds of farming jobs without too much modification when the job involves movement of the farming equipment/vehicle on the field. For example, it can be used for tractor movement whether it is being used for ploughing, tilling, planting, irrigating, fertilizing, harvesting, sorting or hay making and without any need to install sensors on the equipment/vehicle.

Machine learning is used to determine clusters of location points that appear close to each other based on location and/or proximity determination. Since the learning algorithm is governed by certain configuration parameters or features like minimum proximity of adjacent location points, it is very easy to tune the algorithm for different farming tasks entirely on the server which may be completely independent of the device settings. Parameters such as minimum proximity of adjacent location points to be included in the cluster may be provided to the system by the fleet manager/application user, e.g., if the two locations points are less than equal to 0.5, 1, 1.5 etc. yards or meters away from each other, they may be assigned as belonging to the cluster. The value as well unit of measurement of distance for determination of a cluster may be provided by the application itself or may be selected and/or entered by the fleet manager/application user as desired.

Motion of farming equipment on land may have unique patterns that are different from the motion of regular vehicles on the road. Farming equipment may move on the road as well as on off-road fields. Herein we describe a way to analyze motion of farming equipment (without the help of a map) to determine if the equipment is active on the field or just relocating to another part of the field for a different job. This is done purely through the use of location data provided by a location tracking system, for example, a GPS tracking system, which is sent to the internet cloud directly through devices, for example, SIMs, installed on the farming equipment/vehicle.

The goal of this exercise is to determine daily usage of the vehicle/equipment with respect to farming vs. non-farming activity. The vehicle/equipment can be owned or leased. This analysis of equipment use for farming or non-farming activity enables usage-based billing without installing expensive sensors on the tools attached to the farming equipment/vehicle. The analysis is done purely based on footprints determined by the location tracking system and left by the vehicle/farming equipment when it moves on the ground and any additional data captured from the engine or equipment's/vehicle's internal data bus.

There are two different scenarios for this analysis, both of which use different approaches to determine daily usage of the vehicle/equipment with respect to farming vs. non-farming activity. These two different approaches use rule based algorithms provided by the rules engine. Different algorithms may be used in the above mentioned usage scenarios. For example, scenario 1 may use a decision tree algorithm, e.g., decision tree algorithm may used for detecting usage in near real time. This algorithm uses various configured pattern thresholds such as count of turns, degree of turns, distance between two turns, time between two turns, continuously mark boundary points of usage for on-line area calculation using different formulae, e.g., heron formula, to qualify vehicle usage for farm activities, whereas scenario 2 may use a clustering algorithm, e.g., the clustering algorithm may augment the output of real time decision tree algorithm by re-calculating farm area precisely using the decision tree algorithm as explained above.

The area covered by the use may be calculated as follows. As discussed above, a clustering algorithm is used to get area farmed, a concave hull is drawn around area farmed using custom method. The custom method to draw concave hull involves creating triangles of all the points inside cluster, the triangles that are bigger than average size of all triangles are removed from the cluster. A union of all triangles is taken and only external edges of boundary triangles are kept to produce a polygon. The area of the resulting polygon is calculated.

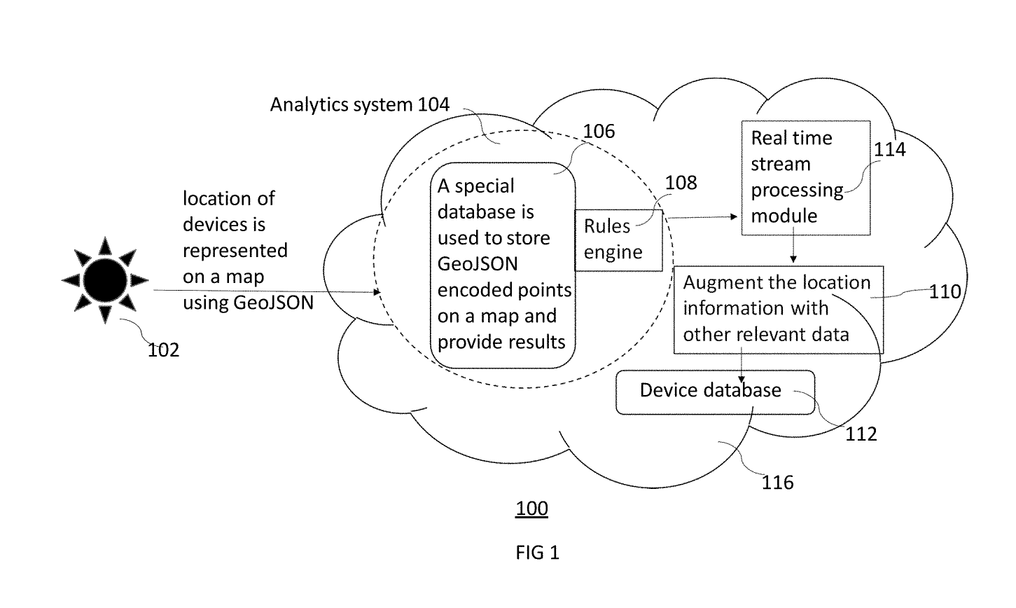

FIG. 1 illustrates an overview diagram for the system 100 used according to an embodiment of the invention. The system 100 used for distinguishing job status through motion analysis includes a memory, a processor, a device 102 including a location tracking system and a server 116 including analytics system 104 having a storage database 106 and a rules engine 108, wherein the processor collects and transmits device information to a server 116, the storage database 106 stores the received device information, the analytics system 104 analyzes the device information to determine a predetermined set of features from the received device information, and the rules engine 108 provides rules to determine if the movement of the device can be classified as farming or non-farming activity.

The device 102 acts as a data generator and/or collector that generates location data and/or collects equipment/vehicle information, whereas server 116 works as a data ingestion module, which captures data generated by the device 102 and stores the captured data. The server 116 may be a physical server or may reside in a cloud.

The analytics system 104 includes a special document database 106 that has GeoJSON support, which may also be known as a location aware database. The analytics system may further provide reporting capabilities and may additionally or alternatively provide deep learning capabilities. The knowledge extracted from the deep-learning and stored in the device database described below in scenario 2 may be fed into the short-term alerting used in alerting capabilities using small time windows in the recent past of the real time stream processing module of scenario 1.

The sever 116 may also include a real-time stream processing module 114, which further includes key-value long term repository that gives current status or status within a time range and in-memory key-value short-term repository which has GeoJSON support for checking Geo proximity and containment. The real time stream processing module 114 may additionally provide alerting capabilities using small time windows in the recent past.

This embodiment, for example, scenario 1, involves usage of a processor/computer to record the position of the device 10 installed in the farming equipment based on location and direction of the farming equipment 102 in real-time as it moves on the field or road and stores it in a storage database 106. The device 10 may be a device enabled for connectivity, and/or includes a module e.g., SIM that enables the connectivity, to a network.

The first scenario described herein is near-real-time, where the job status of the vehicle/equipment may be determined as soon as possible either once the equipment's/vehicle's ignition is turned on or when the vehicle/equipment starts working on the field for a farming job. This is achieved by analyzing streaming data received by the database hosted either on a dedicated server or on a cloud server. This analysis may have some possibility of error, the acceptable range for which may be predetermined.

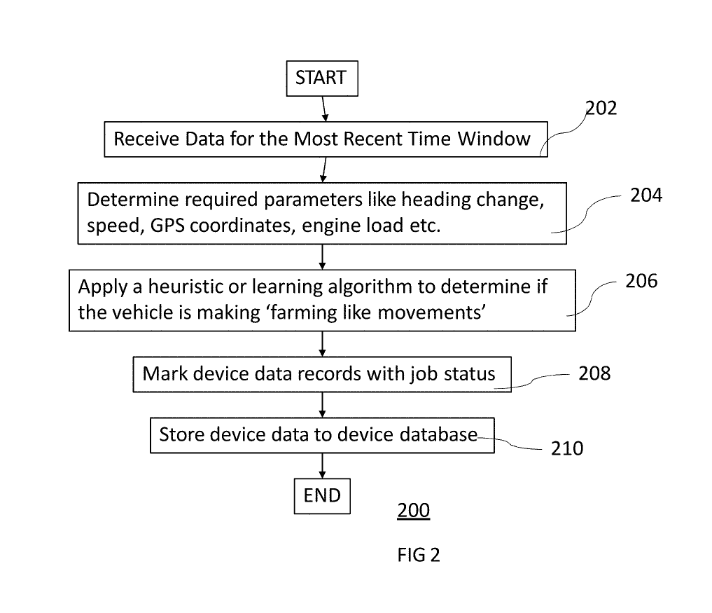

FIG. 2 describes an exemplary method flow used by system 100 described above, illustrating scenario 1 according to an embodiment described herein. For scenario 1, also known as a near real-time use-case, the method relies on heuristic analysis over a short time-window for determination of job status, resulting in determination of the job status as soon as the vehicle/equipment has commenced a job on the field. Various types of data may be generated and/or collected by the device, for example, by a SIM installed in a vehicle or equipment, and may include ignition status of the vehicle/equipment, ‘heading’ or the compass angle where the vehicle/equipment is pointing, ground ‘speed’ of the vehicle/equipment, the actual ‘location’ of the vehicle/equipment, the ‘engine load’, the average ‘throttle position’ and amount of ‘oxygen usage’, start time of the movement, stop time of the movement. This data is collected via step 202, sanitized and placed in cloud storage 104. From the collected data, required parameters/features including heading change, speed, location coordinates, engine load etc. may be determined via step 204.

While data makes its way to the cloud, it passes through a stream processing pipeline where a decision is made whether the vehicle/equipment is moving in a field or on a straight road. To make a decision here, a machine learned model that has been built by analyzing bulk data taken over several days is employed. For example, a heuristic or learning algorithm may be used to determine if the vehicle/equipment is making ‘farming like movements’ via step 206. The algorithm relies on the fact that when vehicles/equipment move on land doing a farming job, (1) they make frequent changes in direction (2) they move very slowly and (3) repeatedly visit the same spot or brush close to the same spot. The algorithm may take any or all the above values and use a decision tree to determine if the vehicle/equipment is making movements that mimic a farming activity. This determination may be performed by analyzing information available within a predetermined time-window, for example, if a vehicle makes 7-8 turns with more than 120 degree angle within 10-20 minutes, the activity may be determined to be a farming activity. The number of turns, the angle of turns and the time window noted herein are for examples only, and other parameters for number of turns, the angle of turns and the time window may also be used.

The device data records are then marked with job status via step 208 and are stored as device data to the device database via step 210. During this process, it is enhanced or augmented with additional information like time difference between records or reference data obtained from the application's user interface. This augmented data is then stored in a device database which may then be used for deep analysis. Additionally or alternatively, the stored data in the device database may be analyzed in bulk to determine the clusters formed by vehicle/equipment movements.

The learning is done in two steps: 1. Generation of the output class variables, e.g., heading, speed and ignition status, etc., using a clustering algorithm, e.g., Density-Based Spatial Clustering of Applications with Noise (DBSCAN) clustering algorithm. This provides the necessary input for a supervised learning algorithm that is used during stream processing as machine learned model discussed above and 2. Generation of feature sets involving rate of heading change, and change of displacement between current position and past ‘k’ positions. A learning model is built using the feature sets extracted above by analyzing data over an extended period of time. This learning model is fed into the stream processing pipeline to make predictions in step stream processing as machine learned model discussed above.

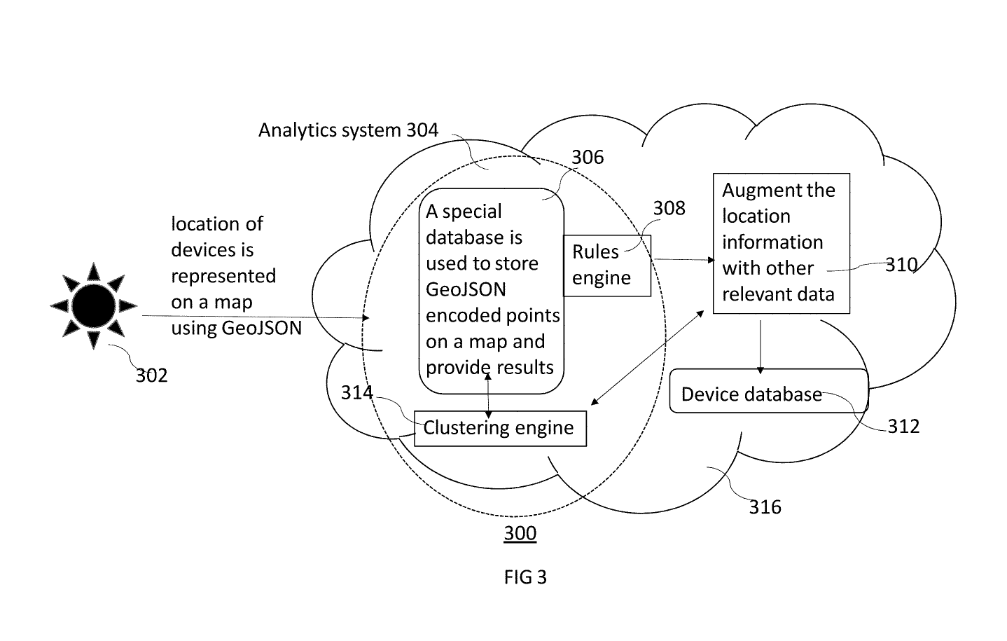

FIG. 3 is an overview diagram for system 300 used for distinguishing job status through motion analysis according to an embodiment described herein. The system 300 used for distinguishing job status through motion analysis includes a memory, a processor, a device 302 including a location tracking system and a server 316 including an analytics system 306 having a storage database 304, a rules engine 308, wherein the server 316 receives the device information transmitted by the device 302, the storage database 306 stores the received device information, the analytics system 304 analyzes the device information to determine a predetermined set of features from the received device information, and the rules engine 308 provides rules to determine if the movement of the device 302 can be classified as farming or non-farming activity. In an embodiment, the system 300 may additionally include a clustering engine 314.

The device 302 acts as a data generator and/or collector that generates location data and/or collects equipment/vehicle information, whereas server 316 works as a data ingestion module, which captures or receives data transmitted by the device 302 and stores the received data. The server 316 may be a physical server or may reside in a cloud. The analytics system 304 includes a document/storage database 306 that has GeoJSON support, which may also be known as a location aware database. It further provides reporting capabilities and may additionally or alternative provide deep learning capabilities. The knowledge extracted from the deep-learning and stored in the device database is fed into the short-term alerting used in alerting capabilities using small time windows in the recent past of the real time stream processing module described above as scenario 1 in the description accompanying FIGS. 1 and 2.

This embodiment, for example, scenario 2, is where a more accurate analysis may be provided, but the analysis may or may not be performed in real-time. The data collected at predetermined time intervals may be analyzed in batch mode at the end of the pre-determined time interval, for example, end of the hour or end of the day when all movement for the day is finished and the vehicle/equipment is at rest, or at the end of the week or at the end of the month.

A special kind of encoding called GeoJSON is used to represent such points on a map. Storage database 304 is a special kind of database used to handle GeoJSON encoded points on a map, also known as a location aware database, and to provide results in an efficient manner. An analytics system 306 analyzes pattern of the movement of the farming equipment 302 to assess the kind of task it is performing using the rules provided by the rules engine 308.

After processing, the data is pushed into the device database 312. During this process, it may be enhanced or augmented using data augmentation module 310 with additional information like time difference between records or reference data obtained from the application's user interface. This augmented data is then stored in the device database 312 which may be used for deep analysis. Stored data in the device database 312 may be analyzed in bulk to determine the clusters formed by vehicle/equipment movements.

Parameters such as minimum proximity of adjacent location points to be included in the cluster may be provided to the system by the fleet manager/application user, e.g., if the two locations points are less than equal to 0.5, 1, 1.5 etc. yards or meters away from each other, they may be assigned as belonging to the cluster. The value as well unit of measurement of distance for determination of a cluster may be provided by the application itself or may be selected and/or entered by the fleet manager/application user as desired.

The learning may be performed in two steps: 1. Generation of the output class variables, e.g., heading, speed and ignition status, etc., using a clustering algorithm, e.g., Density-Based Spatial Clustering of Applications with Noise (DBSCAN) clustering algorithm. This provides the necessary input for a supervised learning algorithm that is used during stream processing as machine learned model discussed above and 2. Generation of feature sets involving rate of heading change, and change of displacement between current position and past ‘k’ positions. A learning model is built using the feature sets extracted above, by analyzing data over an extended period of time. This learning model is fed into the stream processing pipeline to make predictions in step stream processing as machine learned model discussed above.

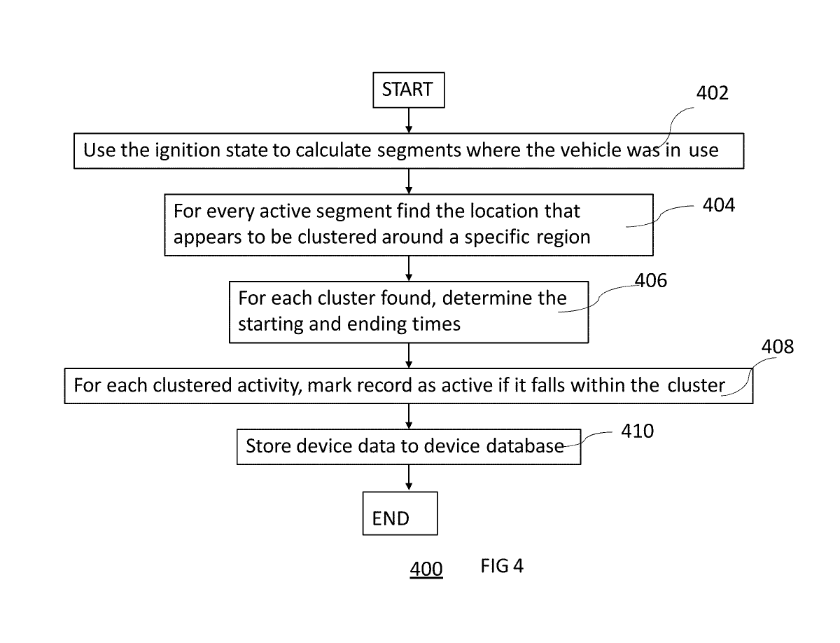

FIG. 4 illustrates an exemplary method flow 400 used by system 300 described above, illustrating scenario 2 according to an embodiment described herein. For scenario 2, also known as batch processing, it may be assumed that all activity pertaining to movement of the vehicle/equipment is already complete. Active segments of the vehicle/equipment when the vehicle/equipment was in motion may be determined by looking at the ignition state of the vehicle/equipment via step 402. All active segments for the vehicle/equipment are compiled and locations that appear to form a ‘cluster’ within the segment may be determined via step 404.

A cluster may be defined as collection of points geographically and/or temporally close to each other. Thus, location points within the cluster may be geographically and temporally close to each other. The machine learning algorithm used for this analysis is DBSCAN with a specialized distance function to describe the proximity of the points. No limitation may be imposed on the number of clusters, the shape of the cluster, or the number of points contained within a cluster.

Parameters such as minimum proximity of adjacent location points to be included in the cluster may be provided to the system by the fleet manager/application user, e.g., if the two locations points are less than equal to 0.5, 1, 1.5 etc. yards or meters away from each other, they may be assigned as belonging to the cluster. The value as well unit of measurement of distance for determination of a cluster may be provided by the application itself or may be selected and/or entered by the fleet manager/application user as desired.

When a cluster of points is determined, earliest time and the latest time when the vehicle/equipment was confined within the cluster may be determined via step 406. The ‘ON-JOB’ status of the vehicle/farming equipment may be determined for that time window. The device data records are then marked with job status via step 408 and stored as device data to the device database via step 410.

During this process, the data is enhanced or augmented with additional information like time difference between records or reference data obtained from the application's user interface. This augmented data is then stored in a document storage or device database which may then be used for deep analysis. Stored data in the device database may be analyzed in bulk to determine the clusters formed by vehicle/equipment movements.

Area covered by the use may be calculated as follows. As discussed above, a clustering algorithm is used to get area farmed; and a concave hull is drawn around area farmed using custom method. The custom method to draw concave hull involves creating triangles of all the points inside cluster, the triangles that are bigger than average size of all triangles are removed from the cluster. A union of all triangles is taken and only external edges of boundary triangles are kept to produce a polygon. The area of the resulting polygon is calculated.

The learning may be performed in two steps: 1. Generation of the output class variables, e.g., heading, speed and ignition status, etc., using a clustering algorithm, e.g., Density-Based Spatial Clustering of Applications with Noise (DBSCAN) clustering algorithm. This provides the necessary input for a supervised learning algorithm that is used during stream processing as machine learned model discussed above and 2. Generation of feature sets involving rate of heading change, and change of displacement between current position and past ‘k’ positions. A learning model is built using the feature sets extracted above by analyzing data over an extended period of time. This learning model is fed into the stream processing pipeline to make predictions in step stream processing as machine learned model discussed above in the description for FIGS. 1 and 2.

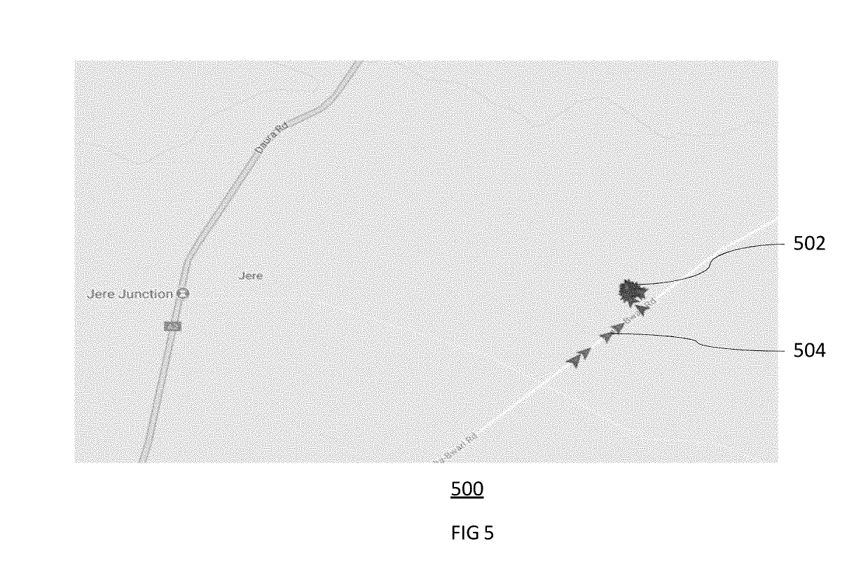

FIG. 5 illustrates an exemplary user interface for the system and method according to an embodiment of the invention. For example, tractor movement corresponding to the farming activity is illustrated as a clustered patch 502, whereas tractor movement corresponding to the non-farming activity is shown by arrows 504. The classification of movement may also be illustrated using different colors, for example, tractor movement showing farming activity in red 502, with non-farming activity is shown in green 504.

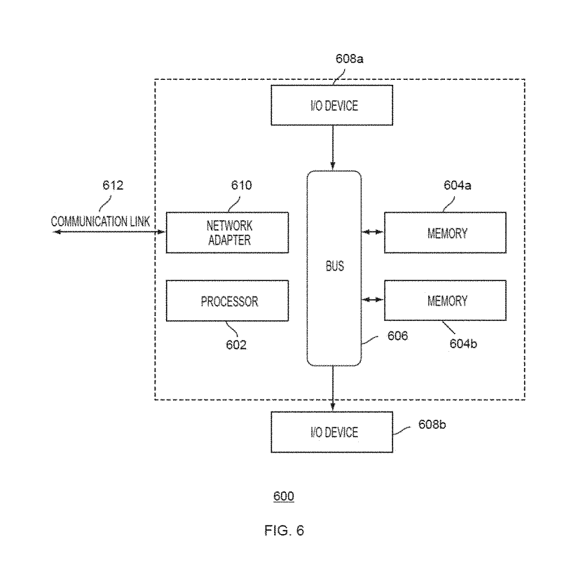

FIG. 6 illustrates a data processing system 600 suitable for storing the computer program product and/or executing program code in accordance with an embodiment of the present invention. The data processing system 600 includes a processor 602 coupled to memory elements 604a-b through a system bus 606. In other embodiments, the data processing system 600 may include more than one processor and each processor may be coupled directly or indirectly to one or more memory elements through a system bus.

Memory elements 604a-b can include local memory employed during actual execution of the program code, bulk storage, and cache memories that provide temporary storage of at least some program code in order to reduce the number of times the code must be retrieved from bulk storage during execution. As shown, input/output or I/O devices 608a-b (including, but not limited to, keyboards, displays, pointing devices, etc.) are coupled to the data processing system 600. I/O devices 608a-b may be coupled to the data processing system 600 directly or indirectly through intervening I/O controllers (not shown).

In FIG. 6, a network adapter 610 is coupled to the data processing system 602 to enable data processing system 602 to become coupled to other data processing systems or remote printers or storage devices through communication link 612. Communication link 612 can be a private or public network. Modems, cable modems, and Ethernet cards are just a few of the currently available types of network adapters.

Embodiments of the process described herein can take the form of an entirely software implementation, or an implementation containing both hardware and software elements. Embodiments may be implemented in software, which includes, but is not limited to, application software, firmware, resident software, microcode, etc.

The steps described herein may be implemented using any suitable controller or processor, and software application, which may be stored on any suitable storage location or computer-readable medium. The software application provides instructions that enable the processor to cause the receiver to perform the functions described herein.

Furthermore, embodiments may take the form of a computer program product accessible from a computer-usable or computer-readable medium providing program code for use by or in connection with a computer or any instruction execution system. For the purposes of this description, a computer-usable or computer-readable medium can be any apparatus that can contain, store, communicate, propagate, or transport the program for use by or in connection with the instruction execution system, apparatus, or device.

The medium may be an electronic, magnetic, optical, electromagnetic, infrared, semiconductor system (or apparatus or device), or a propagation medium. Examples of a computer-readable medium include a semiconductor or solid state memory, magnetic tape, a removable computer diskette, a random access memory (RAM), a read-only memory (ROM), a rigid magnetic disk, and an optical disk. Current examples of optical disks include DVD, compact disk-read-only memory (CD-ROM), and compact disk-read/write (CD-R/W).

Any theory, mechanism of operation, proof, or finding stated herein is meant to further enhance understanding of the present invention and is not intended to make the present invention in any way dependent upon such theory, mechanism of operation, proof, or finding. It should be understood that while the use of the words “preferable”, “preferably” or “preferred” in the description above indicates that the feature so described may be more desirable, it nonetheless may not be necessary and embodiments lacking the same may be contemplated as within the scope of the invention, that scope being defined by the claims that follow. In addition, it should be understood that while the use of words indicating a sequence of events such as “first” and “then” shows that some actions may happen before or after other actions, embodiments that perform actions in a different or additional sequence should be contemplated as within the scope of the invention as defined by the claims that follow.

As used herein, the term “communication” is understood to include various methods of connecting any type of computing or communications devices, servers, clusters of servers, using cellular, wired and/or wireless communications networks to enable processing and storage of signals and information, and where these services may be accessed by applications available through a number of different hardware and software systems, such as but not limited to a web browser terminal, mobile application (i.e., app) or similar, and regardless of whether the primary software and data is located on the communicating device or are stored on servers or locations apart from the devices.

As used herein the terms “device”, “appliance”, “terminal”, “remote device”, “wireless asset”, etc. are intended to be inclusive, interchangeable, and/or synonymous with one another and other similar communication-based equipment for purposes of the present invention, even though one will recognize that functionally each may have unique characteristics, functions and/or operations which may be specific to its individual capabilities and/or deployment.

Similarly, it is envisioned by the present invention that the term “cellular network” includes networks using one or more communication architectures or methods, including but not limited to: Code division multiple access (CDMA), Global System for Mobile Communications (GSM) (“GSM” is a trademark of the GSM Association), Universal Mobile Telecommunications System (UMTS), Long Term Evolution (LTE), 4G LTE, 5G, wireless local area network (WIFI).

Although the present invention has been described in accordance with the embodiments shown, one of ordinary skill in the art will readily recognize that there could be variations to the embodiments and those variations would be within the spirit and scope of the present invention. Accordingly, many modifications may be made by one of ordinary skill in the art without departing from the spirit and scope of the present invention.

What is claimed is:

1. A computer implemented method for distinguishing job status through motion analysis, the method comprising:
receiving device information from a device,
determining a predetermined set of features from the received device information, and
applying rules to determine if the movement of the device can be classified as farming or non-farming activity.

2. The computer-implemented method of claim 1, wherein device information further comprises any of: ignition status of the device, location of the device, direction where the device is heading, speed of the device, engine load of the device, start time of the movement, stop time of the movement or a combination thereof.

3. The computer-implemented method of claim 2, wherein the predetermined set of features further comprise any of: ignition status of the device, location of the device, direction where the device is heading, speed of the device, engine load of the device, active segments for the device or a combination thereof.

4. The computer-implemented method of claim 1, wherein applying rules to determine if the movement of the device comprises any of using a heuristic algorithm, using a learning algorithm or a combination thereof.

5. The computer-implemented method of claim 3, wherein applying rules to determine if the movement of the device comprises:
using ignition status of the device to calculate segments where the device was active,
finding a location that appears to be clustered around a specific region for every active segment,
determining the starting and ending times for each cluster found, and
marking the record as farming activity if it falls within the cluster for each clustered activity.

6. A system for distinguishing job status through motion analysis, the system comprising a device including a location tracking system and a server including a storage database, an analytics system and a rules engine, wherein
the server receives device information transmitted by the device,
the storage database stores the received device information,
the analytics system analyzes the device information to determine a predetermined set of features from the received device information, and
the rules engine provides rules to determine if the movement of the device can be classified as farming or non-farming activity.

7. The system of claim 6, wherein device information further comprises any of: ignition status of the device, location of the device, direction where the device is heading, speed of the device, engine load of the device or a combination thereof.

8. The system of claim 7, wherein the predetermined set of features further comprise any of: ignition status of the device, location of the device, direction where the device is heading, speed of the device, engine load of the device or a combination thereof.

9. The system of claim 6, wherein rules to determine if the movement of the device comprise any of using a heuristic algorithm, using a learning algorithm or a combination thereof.

10. The system of claim 8, wherein the rules to determine if the movement of the device comprises:
using the ignition status of the device to calculate segments where the device was active,
finding a location that appears to be clustered around a specific region for every active segment,
determining the starting and ending times for each cluster found, and
marking the record as farming activity if it falls within the cluster for each clustered activity.

11. A non-transitory computer-readable medium having executable instructions stored therein that, when executed, cause one or more processors corresponding to a system having a device and a server comprising an analytics system to perform operations comprising:
receiving data comprising device information from the device,
determining a predetermined set of features from the received device information, and
applying rules to determine if the movement of the device can be classified as farming or non-farming activity.

12. The non-transitory computer-readable medium of claim 11, wherein device information further comprises any of: ignition status of the device, location of the device, direction where the device is heading, speed of the device, engine load of the device or a combination thereof.

13. The non-transitory computer-readable medium of claim 12, wherein the predetermined set of features further comprise any of: ignition status of the device, location of the device, direction where the device is heading, speed of the device, engine load of the device or a combination thereof.

14. The non-transitory computer-readable medium of claim 11, wherein applying rules to determine if the movement of the device comprises any of using a heuristic algorithm, using a learning algorithm or a combination thereof.

15. The non-transitory computer-readable medium of claim 13, wherein applying rules to determine if the movement of the device comprises:
using the ignition status of the device to calculate segments where the device was active,
finding a location that appears to be clustered around a specific region for every active segment,
determining the starting and ending times for each cluster found, and
marking the record as farming activity if it falls within the cluster for each clustered activity.
